(19) United States
(12) Patent Application Publication
(10) Pub. No.: US 2013/0332076 A1
(43) Pub. Date: Dec. 12, 2013

(54) STORING A ROUTE AND SHARING THE ROUTE

(71) Applicant: Leigh M. Rothschild, Sunny Isles Beach, FL (US)

(72) Inventor: Leigh M. Rothschild, Sunny Isles Beach, FL (US)

(73) Assignee: REAGAN INVENTIONS, LLC, Sunny Isles Beach, FL (US)

(21) Appl. No.: 13/493,484

(22) Filed: Jun. 11, 2012

(51) Int. Cl. G01C 21/36; G01C 21/00

(52) U.S. Cl. 701/533; 701/532

(57) ABSTRACT

A system and method for storing a route and sharing the route with other users. The system and method allow a user to record a particular route and share said route and comments with other users. The system is integrated with a navigation system having a display screen and interface to allow a user to easily record the route. Further, the system includes a communication module for uploading the route to devices maintained by other users or a subscription based website.

### BACKGROUND

1. Field

A system and method for storing a driving route and sharing the driving route with other users.

2. Description of the Related Art

Navigation Systems and computer programs that generate maps and driving directions are well known in the prior art. Typically, these systems generate step-by-step directions based on a starting point or entered by the user and a end point entered by the user. Several companies, notably Garmin, TomTom, and Magellan have developed handheld or dashboard mounted navigation systems using Global Positioning Systems satellites to determine a user's current location and gives driving directions to a selected end point based on distances before a required driving maneuver. For instance, the navigation system may indicate “Left turn in 1 mile.” Additionally, navigation systems are now standard equipment in many new vehicle models.

Most navigation systems determine driving routes based on preloaded map software. In vehicles that have standard navigation systems, the maps are generally uploaded onto a small computer disc that is inserted into a disc drive mounted in the vehicle. The disc may be uploaded or replaced occasionally. Dashboard mounted navigation systems, such as Garmin systems, are sold with maps preloaded on the internal hard drive. Users may connect the Garmin navigation system to a personal computer via a USB port and download updated software from a website maintained by Garmin. Other systems may update map software through satellite communications or 3G technology.

Most navigation systems give the shortest distance route or the fastest route based on posted speed limit signs as the default driving directions. Some systems allow the user to select driving route options such as “highways only” or “no toll roads.” In these systems, the driver can select between a few very broad options for driving routes. However, for the most part, drivers are limited to what is considered to be the shortest distance route or the fasted route by the system. In each case, the system fails to account for traffic as a result of volume or construction and users are forced to watch their estimated arrival time as posted on the navigation system display screen tick further and further away. At other times, a user may drive through a dangerous environment, a poorly maintained roadway, or an ugly urban sprawl, completely unaware of a much more pleasant route that would add mere minutes to their trip.

Several websites, such as MapQuest.com and Google Maps allow a user to generate a driving route based on a starting point and an end point. These programs generate a map with a highlighted driving route and turn-by-turn directions. A user can alternate the driving route by moving the highlighted route on the map. In this situation, the user can avoid areas that they know are typically problematic. However, the user would have to be familiar with the area generally, and the route specifically to know to avoid certain areas. A user could also conceivably research the area and the driving route, but this is time-consuming and tedious. Additionally, step-by-step driving directions printed from a computer can be hazardous because the driver must constantly check the directions, thereby taking his eyes off the road.

In many cases, a driver will be familiar with a majority of a driving route. For instance, a driver may know how to get to a town, but not know where a particular address is within the town. In these circumstances, the driver can ignore the driving directions given by the navigation system if the driver knows a faster route than that suggested by the system or merely wishes to avoid certain areas. The navigation system will update the driving route based on the current location of the vehicle. In most cases, drivers have a better sense of preferred driving routes than navigation systems.

### SUMMARY

A system and method for storing a route and sharing the route with other users. The system and method allow a user to record a particular route and share said driving and comments with other users. The system is integrated with a navigation system having a display screen and interface to allow a user to easily record the route. Further, the system includes a communication module for uploading the route to devices maintained by other users or a subscription based website.

A method is provided storing a route and sharing the route with other users. The method includes a user entering a destination into the navigation system. Software loaded on the storage medium of the navigation system determines a route based on an estimated shortest total driving time.

The method further includes the step of displaying each step of the route and alerts the user of maneuvers necessary to maintain the selected route. If the user follows the route, the user will reach the destination.

The method may also include the step of deviating from the directions. In this step, the user may purposely ignore the directions to avoid a particular road or area. Alternately, the user may be unable to make a turn do to a detour, traffic, or any other reason.

The method further includes the step of updating the route to accommodate a user who has missed a turn.

The method further includes the step of recording a route. The user may make comments or a review off the route available to other users. The user may press a record button on the navigation system and the navigation system will note each maneuver.

Still further, the method includes the step of compile step-by-step directions based on the recorded user's route and storing the route in the navigation system. Over a period of time, the user may use and record several different routes to travel between a particular set of start and end points. The several routes will be stored by the navigation system and may be sorted according to date, time, or distance. The user may choose a route from among the several routes based on the time of travel or any other factor.

The method also includes the step of making the user-generated route available to other users. The route may be uploaded to the internet through a communication module in the navigation system. Alternatively, the user may be required to connect the navigation system to a website.

The method also includes the step of adding comments and reviews to the route. The user who created the route or other users may provide comments and reviews of the route, thereby allowing other users to chose a route based on the comments of other users.

### BRIEF DESCRIPTION OF THE DRAWINGS

The above and other aspects, features, and advantages of the disclosure will become more apparent in the light of the following detailed description when taken in conjunction with the accompanying drawings in which:

FIG. 1 is a schematic illustration of a system for recording a driving route and sharing the driving route with users; and

FIG. 2 is a flow chart illustrating a method for recording a driving route and sharing the driving route with users.

### DETAILED DESCRIPTION

Embodiments of the disclosure will be described herein with reference to the accompanying drawings. In the following description, well-known functions or constructions are not described in detail to avoid obscuring the disclosure.

Embodiments of the present disclosure overcome the shortcomings of existing practices and provides a device and system for.

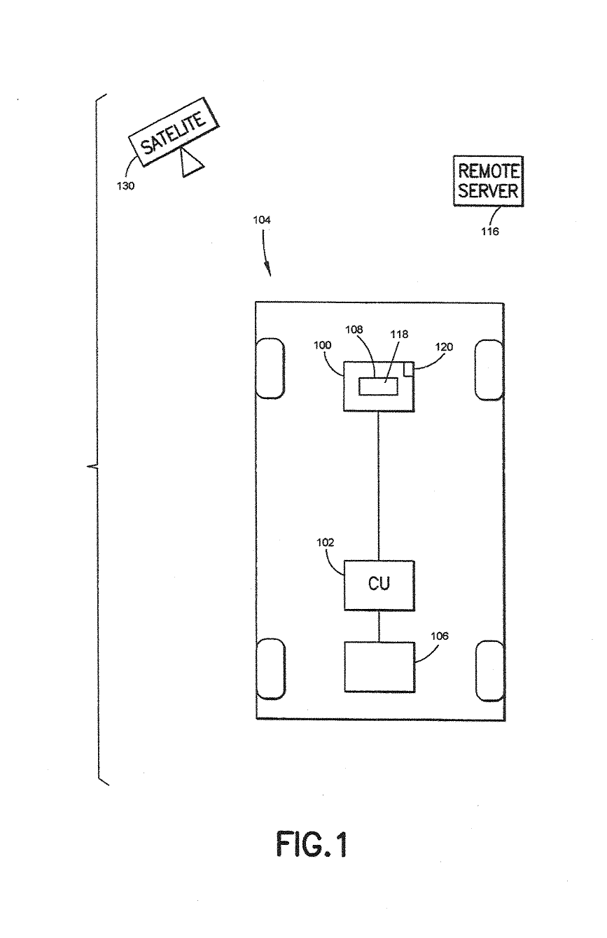

Referring to FIG. 1, a system for storing a for a vehicle and sharing the driving route with other users is provided. The system includes a navigation system 100 connected to a computer processor 102, e.g. a microprocessor, central processing unit, etc., both of which are connected to or mounted on a vehicle 104. The navigation system 100 is configured to create step-by-step directions and to communicate the directions to a user.

The navigation system 100 is connected to a communication module 106 configured to communicate with a satellite relay or wireless network 130, to determine the exact position of the vehicle 104 within a network of roads using Global Positioning System (GPS) technology. The navigation system 100 has a display screen 108 visible to the user of the vehicle 104 displaying the vehicle's 104 position on the network of roads. The display screen 108 is also configured to provide messages. The navigation system 100 further has a user interface 118, such as a touch screen, to allow the vehicle operator to enter a driving destination. The navigation system 100 has a speaker 110 to give audio directions to the driver. The navigation system 100 is also configured to give visual cues to the driver via the display screen 108.

The computer processor 102 will use computer software instructions that have been programmed into the computer processor 102 and conventional computer processing power to interact and organize the traffic flow between the various other modules, sensors, etc. of the vehicle. It is to be understood that the present disclosure may be implemented in various forms of hardware, software, firmware, special purpose processors, or a combination thereof. A system bus 110 couples the various components shown in FIG. 1 and may be any of several types of bus structures including a memory bus or memory controller, a peripheral bus, and a local bus using any of a variety of bus architectures. The device also includes an operating system and micro instruction code preferably residing in read only memory (ROM). The various processes and functions described herein may either be part of the micro instruction code or part of an application program (or a combination thereof) which is executed via the operating system.

The navigation system 100 is configured with a record function. The record function 120 may be in the form of a button that is pressed by the user to record the route. In an alternate embodiment, the record function 120 may be voice activated by the user. The recorded route will be stored by the computer processor 102 and transmitted via a communication module 114 to a remote server 116. The routes stored on the remote server 116 may be accessed by registered users.

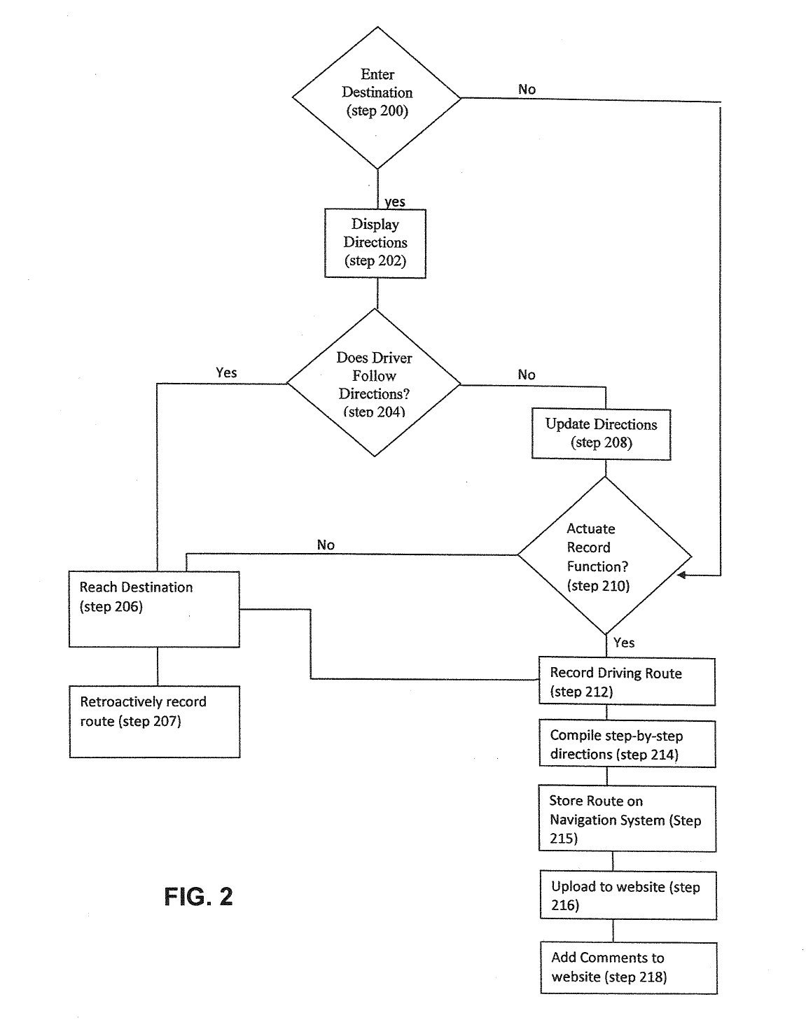

With reference to FIG. 2 a method of the present invention will now be disclosed. The navigation system 100 prompts the user to enter a destination (step 200). If the user enters the destination into the navigation system 100, the navigation system develops a route and displays the directions in a step-by-step fashion (step 202). The user has the option of following each step of the directions developed by the navigation system 100 or deviating from the directions (step 204). If the user follows the directions, the user will reach the destination (step 206).

In an alternate embodiment, the user will deviate from the directions and the navigation system 100 will generate new directions to the destination based on the vehicle's 104 location (step 208). The user may chose to deviate from the directions to take an alternate route. In another step of this embodiment, the user activates the record feature on the navigation system 100 by actuating the record function 120 (step 210).

In another step, the computer processor 102 records the alternate route (step 212). In conjunction with the GPS technology of the navigation system 100, the computer processor 102 records the precise location of each driving maneuver made on the alternate route. In the next step, the computer processor 102 generates step-by-step directions based on the alternate route (step 214).

The alternate route is stored on the navigation system (step 215). The user can add notes and comments describing the alternate route (step 218).

In another embodiment of this method, the driver does not enter a destination (step 200). The user activates the record function 120 (step 210) and records a route from a starting point to a destination (step 214). The route is stored in the navigation device. Over a period of time, the user may use and record several different routes to travel between a particular set of start and end points. The several routes will be stored by the navigation system and may be sorted according to date, time, or distance. The user may choose a route from among the several routes based on the time of travel or any other factor.

The method further comprises the step of uploading the route to a website (step 216) and making the route available for other users. Other users can add comments to the route and make suggestions. For instance, a user may warn other users not to use a particular route due to traffic caused by ongoing road construction. In another instance, a user may suggest a first route over a second route due to rush hour traffic. The comments may be sorted by time or day or travel. User comments are retrieved by the navigation device and are displayed on the display screen when the user is choosing a route. Thus, a user is able to choose a route based on the advice and suggestions of other users.

In a further embodiment, the user travels a route without activating the record function. Upon reaching the destination, the user may activate the record function to retroactively record the route (step 207).

Examples of applications of the invention follow. A driver frequently travels from Philadelphia to New York City. The driver is aware of ongoing construction and traffic delays on the New Jersey Turnpike on the route from Philadelphia to New York. The driver drives on local roads to bypass the congested area and records the alternate route using the record button 120 on the navigation system 100. The driver uploads the alternate route to the subscriber based website and adds the comment, “I was able to avoid the traffic on the New Jersey Turnpike between Philadelphia and New York and shortened my trip by fifteen minutes.

A driver is planning a trip from New York to Washington D.C. The driver frequently travels from New York to Philadelphia. The New York to Philadelphia route comprises a portion of the New York to Washington D.C. route. The navigation system prompts the user to use a previously recorded New York to Philadelphia route in building the complete New York to Washington D.C. route. Alternatively, the driver may choose between the previously recorded New York to Philadelphia routes. A driver is planning a trip from New York to Chicago. Prior to departure, the driver accesses the subscriber based website and searches for routes between New York and Chicago. The driver chooses a route based on user comments and reviews and follows said route to Chicago.

A business owner wishes to bring motorists by a business that is not located on main routes of travel. The business owner uploads a route between common starting and ending points that will bring drivers near the business. The business owner may add a comment to the route on the subscriber based website such as, “Stop at my business and receive a 10% discount for mentioning this route.”

While the disclosure has been shown and described with reference to certain preferred embodiments thereof, it will be understood by those skilled in the art that various changes in form and detail may be made therein without departing from the spirit and scope of the disclosure as defined by the appended claims.

1. A method for storing a route and sharing the route, comprising:
recording a route using a navigation system mounted in a vehicle;
saving the route on the navigation system;
uploading the route to a website;
sharing the route with at least one other user; and
entering a destination in the navigation system and displaying step-by-step directions based on a current location of the vehicle and the destination; and
deviating from the step-by-step directions and updating the step-by-step directions based on a new location of the vehicle.

2-3. (canceled)

4. The method of claim 1, wherein
a user of the vehicle instructs the navigation system to begin recording directions from the point at which the user deviated from the step-by-step directions.

5. The method of claim 1, further comprising
the step of adding user-generated comments to a stored routes.

6. The method of claim 5, wherein
the user-generated comments are made available to all users.

7. The method of claim 1, further comprising
sorting stored routes according to date and time.

8. The method of claim 1, wherein
the record function is actuated when a destination is reached and a route is recorded retroactively.

9. The method of claim 1, further comprising
selecting a route from previously-stored routes.

10. A system for storing a route and sharing the route, comprising:
a navigation system configured with a record function;
a computer processor in communication with the navigation system and configured to
develop step-by-step driving directions,
detecting a deviation of the vehicle from the step-by-step driving directions, and
updating the step-by-step driving directions based on a current, deviated location of the vehicle; and
a communication module in communication with a subscriber-based website configured for transmitting the driving route to the website.

11. The system of claim 10, wherein
the communication module communicates with the subscriber-based website via a satellite relay or wireless network.

12. The system of claim 10, wherein
the navigation system is mounted in a vehicle.

13. The system of claim 10, further comprising
a display screen on the navigation system visible to the user and displaying a current location of the vehicle.

14. The system of claim 13, wherein
the display screen displays comments on a route from other users.

15. The system of claim 10, wherein
the record function is a pressable record button.

16. The system of claim 10, wherein
the record function is voice activated.

17. A method for storing a route and sharing the route, the method comprising:
entering a destination into a navigation system mounted in a vehicle;
displaying a set of directions to the destination from a current location of the vehicle;
deviating from the set of directions;
creating an alternate route based on a second location of the vehicle;
activating a recording feature of the navigation system;
recording the alternate route;
compiling step-by-step directions based on the alternate route;
saving the route on the navigation system;
uploading the alternate route to a website; and
commenting on the alternate route on the website.
